(19) United States
(12) Patent Application Publication
(10) Pub. No.: US 2004/0185994 A1
(43) Pub. Date: Sep. 23, 2004

(54) Dunnage converter with knee/hip switch

(76) Inventors: Joseph J. Harding, Mentor, OH (US); Harry H. Lu, Mentor, OH (US); Joost Dijkstra, Klimmen (NL)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 10/788,246

(22) Filed: Feb. 25, 2004

Related U.S. Application Data
(60) Provisional application No. 60/450,003, filed on Feb. 25, 2003.

(51) Int. Cl. B31B 1/14

(52) U.S. Cl. 493/350

(57) ABSTRACT

A dunnage converter with a novel actuating modality in the form of a knee or hip switch that operates the converter while keeping an operator's hands free for packing dunnage into a container. The switch has a pusher pad that can positioned such that a simple bending action of the operator's leg will move the operator's knee into engagement with the pusher pad for actuating the switch that operates the converter to produce a dunnage product. In an alternative arrangement, the pusher pad can be positioned such that a simple shifting of the operator's hip against the pusher pad will actuate the switch to operate the converter.

This application claims the benefit of U.S. Provisional Patent Application No. 60/450,003, filed on Feb. 25, 2003.

### FIELD OF THE INVENTION

The invention herein described relates generally to dunnage converters that convert a stock material, such as sheet stock material, into a dunnage product.

### BACKGROUND OF THE INVENTION

International Publication No. WO/0194107 describes a dunnage converter that converts sheet stock material in a relatively low density dunnage product that is particularly useful as a void-fill product. This dunnage converter can produce the dunnage product at a high rate. As it exits an output chute of the dunnage converter, typically an operator/packer guides and pushes the dunnage product into a container, such as a box, to fill any voids around contents in the box. This is done to prevent the contents from shifting in the box during shipment.

The operator typically controls the converter by using a foot switch, as has been a conventional practice in the industry when the operator manually controls the production of a dunnage product. When the operator is top-filling a continuous stream of boxes and the converter is operating at high speeds, the repetitive use of the foot switch can be tiring, particularly when the operator needs to depress the foot switch more than just a few seconds. When the operator is depressing the foot switch, his or her weight will not be evenly distributed on both of the operator's feet. The foot not depressing the foot switch will usually bear more weight, and the foot pressing the foot switch will bear more of the remaining weight toward the heel than normal.

One may think providing a button for the operator to depress to operate the converter can easily address this problem. However, this would preclude the operator from being able to use both hands to guide and to push the dunnage product into the box as the converter produces the dunnage product.

### SUMMARY OF THE INVENTION

The present invention provides a dunnage converter with a novel actuating modality in the form of a knee or hip switch. The switch has a pusher pad that can be positioned such that a simple bending action of the operator's leg will move the operator's knee into engagement with the pusher pad for actuating the switch that operates the converter to produce a dunnage product. In an alternative arrangement, the pusher pad can be positioned such that a simple shifting of the operator's hip against the pusher pad will actuate the switch to operate the converter.

Accordingly; the present invention provides a dunnage conversion system for converting a stock material into a dunnage product, the system comprising a dunnage converter including a conversion assembly that is driven by a motor to advance the stock material through the converter for conversion of the stock material into the dunnage product; a switch, which when actuated causes the motor to drive the conversion assembly to advance the stock material to be advanced through the converter, the switch including a pusher pad for engagement by the knee or hip of an operator; and a mount for mounting the pusher pad in a vertical orientation for engagement by the knee or hip of the operator.

In a preferred embodiment, the mount includes an upright and an adjustment device for enabling adjustment of the pusher pad along the height of the upright. Preferably at least an outer portion of the pusher pad is resilient, and the pusher pad can be attached to a base for pivotal movement against a biasing force.

The invention also provides a method of converting a stock material into a dunnage product, comprising the step of an operator using his/her knee or hip to engage the pusher pad of the aforesaid dunnage conversion.

Also provided is a method of enabling the production of a dunnage product, comprising the steps of: providing a dunnage converter including a conversion assembly that is driven by a motor to advance the stock material through the converter for conversion of stock material into the dunnage product; and mounting a pusher pad of a switch for engagement by the knee or hip of an operator, the switch being operable when actuated to cause the motor to advance the stock material through the converter.

The foregoing and other features of the invention are hereinafter fully described and particularly pointed out in the claims, the following description and the annexed drawings setting forth in detail an illustrative embodiment of the invention, such being indicative, however, of but one of the various ways in which the principles of the invention may be employed.

### BRIEF DESCRIPTION OF THE DRAWINGS

FIG. 1 is a perspective view-of a dunnage converter system comprising a converter and a knee/hip switch assembly according to the invention.

FIG. 2 is a plan view of the knee/hip switch assembly of FIG. 1.

FIG. 3 is a front elevational view of the knee/hip switch assembly, looking from the line 3-3 of FIG. 2.

FIG. 4 is a side elevational view of the knee/hip switch assembly, looking from the line 4-4 of FIG. 3.

### DETAILED DESCRIPTION

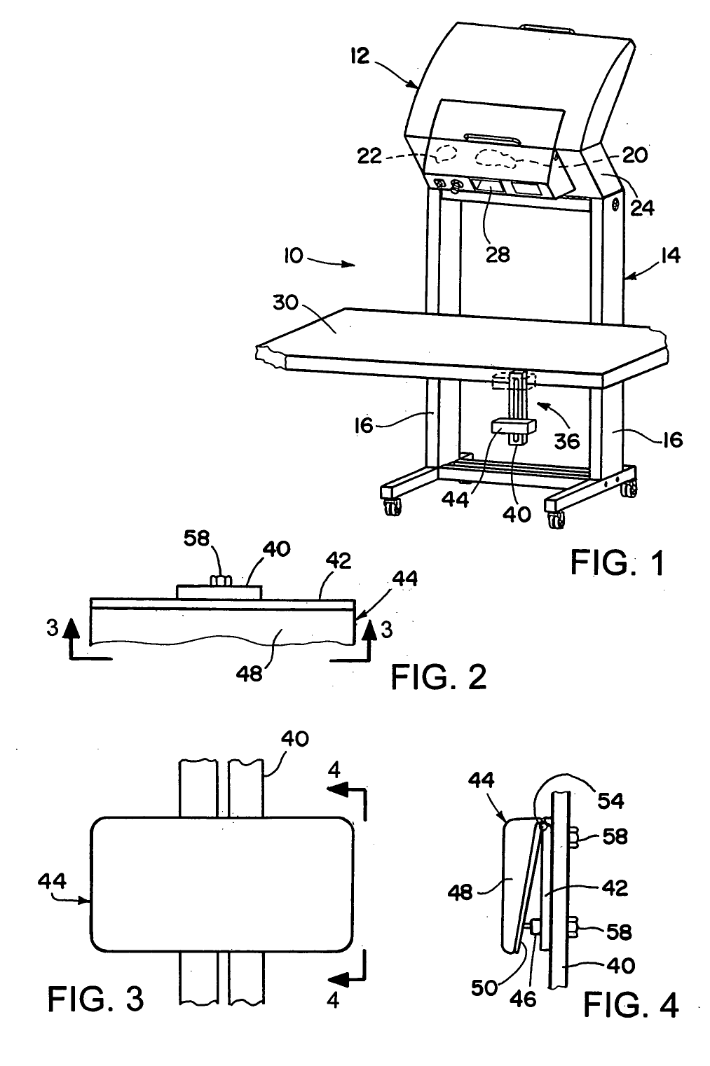

Referring now in detail to the drawings and initially to FIG. 1, a dunnage conversion system in accordance with an embodiment of the present invention is designated generally by reference number 10. The dunnage conversion system 10 includes a dunnage converter 12 and a dunnage converter stand 14 including a pair of transversely spaced upright members 16. The illustrated stand 14 has provision for storing a supply of fan-fold sheet stock material between the upright members 16 in the manner described in International Publication No. WO/0194107, which is hereby incorporated herein by reference in its entirety. The stock material is fed from the supply to the converter, which includes at least one conversion assembly 20, such as a feeding assembly, that is driven by a motor 22 to advance the stock material through the converter for conversion into the dunnage product. The conversion assembly 20 and motor 22 are hidden from view in FIG. 1 by a converter housing 24. Reference may be had to International Publication No. WO/0194107 for details of exemplary converters and the internal components thereof.

The stock material (not shown) preferably is a sheet stock material composed of one or more plies. The ply or plies preferably are made of kraft paper, such as thirty or fifty bias weight kraft paper.

The dunnage product (not shown) produced by the illustrated converter 12 has crumpled, longitudinally extending, irregular lobes. However, it will be appreciated that the dunnage product can take a variety of forms, depending on the converter and the stock material. The dunnage product exits the converter 12 through an exit chute 28. In a typical packaging operation, an operator guides and pushes the dunnage product exiting from the converter into a container, such as a box, that may be supported, for example, on a platform 30 in front of the converter. The platform can be a table top, conveyor, etc. After a desired amount of dunnage product has been produced, such as the amount needed to fill the void in the box, a severing mechanism in the converter housing 24, and thus hidden from view in FIG. 1, can sever the dunnage product.

Operation of the converter 12, and specifically the conversion assembly 20, is controlled by a controller that can be contained within the converter housing 24 as in the illustrated embodiment, or provided as a separate component. More particularly, the controller controls the motor 22 to drive the conversion assembly 20. When power is supplied to the motor 22, it drives the conversion assembly, such as a feeding assembly, which acts on the sheet stock material to pull it from the supply for passage through the conversion assembly and one or more additional conversion assemblies, thereby converting the sheet stock material into a relatively less dense dunnage product. The dunnage product exits the system 10 through the exit chute 28 after passing by the severing assembly, which also is controlled by the controller to sever the dunnage product into one or more discrete sections that can be used to pack items in containers.

For manual control by an operator, the controller has an input connected to a knee/hip switch assembly 36. An operator can engage the knee/hip switch assembly in the below-described manner to cause the motor to drive the conversion assembly for production of a strip of dunnage. Preferably, the dunnage is produced for as long as the switch assembly is engaged. When the operator no longer engages the switch assembly, the motor is stopped and the severing assembly is operated to sever the strip of dunnage product, whereby the thus produced section of dunnage can be removed completely from the converter for placement in the container being filled.

With additional reference to FIGS. 2-4, the illustrated exemplary switch assembly 36 comprises an upright member 40, a base 42, a pusher pad 44 and a switch 46. The pusher pad 44 includes a resilient pad 48 carried on a support 50, which is attached to the base for relative movement. In the illustrated embodiment a hinge 54 pivotally connects the support 50 to the base and is engaged or engageable with the switch 46.

The switch 46 can be, for example, a spring biased normally open switch, which is suitably connected to the controller of the converter 12 such that when closed, the motor 22 is caused to advance the stock material through the converter. However, normally the switch and/or the pusher pad 44 is biased to a position where the switch is not actuated and thus the motor is not powered to produce the dunnage product. As shown, the switch 46 can be mounted to the base 42 at a position that will cause the switch to be actuated, in this case depressed, when the pusher pad 44 is pushed toward the base against the biasing force of the switch and/or other biasing device that can be provided if desired.

The pusher pad 44 can be positioned along the upright member 40 such that an operator's knee or hip can easily push it. A preferred location is shown in solid lines in a position in front of the operator so that bending of the operator's knee will urge the knee forwardly for easy pushing against the pusher pad. Alternatively, the pusher pad 44 can be located at a higher position, shown in broken lines, for engagement by an operator's hip (front of the hip or pelvic region of the operator's body—unless otherwise indicated herein a reference to one's hip is intended to encompass the person's pelvic and waist region) as a result of a slight forward leaning movement of the operator or forward shifting movement of the operator's pelvis. Loosening a fastener or fasteners 58 can effect such adjustment used to attach the base to the upright member. In the illustrated embodiment, the fasteners are bolts that extend through a vertical slot in the upright member to allow for such vertical adjustment. Such vertical adjustment facilitates adapting the height of the pusher pad to accommodate different operators. Of course, those skilled in the art will appreciate that other means can be employed to position the pusher pad at a location where an operator's knee or pelvic region can push it while the operator stands on both feet in front of the container into which the dunnage product is being placed.

As shown, the pusher pad 44 can be horizontally elongated to provide a wider target for the operator's hip or knee. Also, the pusher pad preferably has an outer concave surface for being engaged by a knee or hip, such configuration being more ergonomically friendly.

Although the invention has been shown and described with respect to certain embodiments, equivalent alterations and modifications will occur to others skilled in the art upon reading and understanding this specification and the annexed drawings. In particular regard to the various functions performed by the above described integers (components, assemblies, devices, compositions, etc.), the terms (including a reference to a “means”) used to describe such integers are intended to correspond, unless otherwise indicated, to any integer that performs the specified function of the described integer (i.e., that is functionally equivalent), even though not structurally equivalent to the disclosed structure that performs the function in the herein illustrated exemplary embodiments of the invention. In addition, while a particular feature of the invention may have been described above with respect to only one of several illustrated embodiments, such feature may be combined with one or more other features of the other embodiments, as may be desired and advantageous for any given or particular application.

What is claimed is:

1. A dunnage conversion system for converting a stock material into a dunnage product, the system comprising:
a dunnage converter including a conversion assembly that is driven by a motor to advance the stock material through the converter for conversion of the stock material into the dunnage product;
a switch which when actuated causes the motor to drive the conversion assembly to advance the stock material through the converter, the switch including a pusher pad for engagement by at least one of the knee and the hip of an operator; and
a mount for mounting the pusher pad in a vertical orientation for engagement by at least one of the knee and hip of the operator.

2. A dunnage conversion system as set forth in claim 1, wherein the mount includes an upright and an adjustment device for enabling adjustment of the pusher pad along the height of the upright.

3. A dunnage conversion system as set forth in claim 1, wherein at least an outer portion of the pusher pad is resilient.

4. A dunnage conversion system as set forth in claim 1, wherein the pusher pad includes a support and a resilient pad carried on the support.

5. A dunnage conversion system as set forth in claim 4, wherein the switch is mounted to a base and the support of the pusher pad is attached to the base for pivotal movement.

6. A dunnage conversion system as set forth in claim 5, wherein the pusher pad is biased away from the base.

7. A dunnage conversion system as set forth in claim 1, wherein the pusher pad moves from a first position to a second position to actuate the switch, and the pusher pad is biased toward the first position.

8. A dunnage conversion system as set forth in claim 1, wherein the pusher pad is horizontally elongated.

9. A dunnage conversion system as set forth in claim 8, wherein the pusher pad has an outer concave surface for being engaged by at least one of the knee and hip of the operator.

10. A dunnage conversion system as set forth in claim 1, wherein the pusher pad has an outer concave surface for being engaged by at least one of the knee and hip of the operator.

11. A method of converting a stock material into a dunnage product, comprising the step of an operator using his/her knee or hip to engage the pusher pad of a dunnage conversion system as set forth in claim 1.

12. A method as set forth in claim 11, comprising the step of supplying stock material for conversion by the converter.

13. A method of enabling the production of a dunnage product, comprising the steps of:
providing a dunnage converter including a conversion assembly that is driven by a motor to advance the stock material through the converter for conversion of stock material into the dunnage product; and
mounting a pusher pad of a switch for engagement by the knee or hip of an operator, the switch being operable when actuated to cause the motor to drive the conversion assembly to advance the stock material through the converter.

14. A method as set forth in claim 13, comprising the step of adjusting the vertical height of the pusher pad.
